(19) United States
(12) Patent Application Publication
(10) Pub. No.: US 2008/0018484 A1
(43) Pub. Date: Jan. 24, 2008

(54) Appliance and utility sentry

(76) Inventor: Merrell C. Sager, Olympin, WA (US)

Correspondence Address: MERRELL C. SAGER, 9845 LITTLEROCK RD. SW, OLYMPIA, WA, 98512, US

(21) Appl. No.: 11/489,851

(22) Filed: Jul. 20, 2006

(51) Int. Cl. G08B 17/10

(52) U.S. Cl. 340/628

(57) ABSTRACT

An portable automatic power interruption system or Appliance and Utility Sentry (AUS); consisting of a DC or AC battery powered smoke detector of the present invention purpose is to provide an early warning of smoke or fumes. The smoke detector sensor, sensing smoke or fumes of a hazardous condition responds by an alarm. While emitting an radio signal to a remote RF receiver of a remote switch and activating a clock timer which acts as a time delay in advance activating a motor driven retraction device, which in turn when activated retracts a cable attached to a power systems circuit breakers toggle, and thereby tripping the desired circuit breaker,to an off position for the disruption of power to a utility, or appliance, before a smoke hazard turns into a fire or explosive hazard.

### CROSS REFERENCE TO RELATED APPLICATIONS

Not applicable.

### STATEMENT REGARDING FEDERALLY APPROVED RESEARCH OR DEVELOPMENT

Not applicable

### BACKGROUND OF THE INVENTION

1. Field of the Invention

The present invention relates generally to devices for automatically interrupting electric power to an electric circuit when smoke and fumes have been detected, and more particularly, to such utilities and devices that are activated by a signal generated by a smoke detector and or hazard detector.

2. Background Art

Appliances having electric heating elements, such as electric hot plates, kitchen ranges, and toasters, are common sources of accidental smoke, gas fumes, or clothes drier due to inadvertence or improper usage of the appliance. Devices have previously been described to limit the smoke, fire and electrical hazards presented in such instances by automatically shutting off electrical power to an appliance when one or more such hazards have been detected.

Knutson disclosed a kitchen range safety shut off, U.S. Pat. No. 4,659,909, having an electrical relay to interrupt the supply of power to the range. The relay was wired to an electric signal adjacent to an electric kitchen range. In one embodiment, the shutoff unit was hard wired into the electric circuit of, building containing the range. In an alternative embodiment, the range had an electric power plug for insertion into a standard wall receptacle, and the relay of the shut off unit was interposed between the plug and the receptacle. The requirement that the smoke detector be equipped with an electric signal output terminal, however, limited the usefulness of the shut off, since not all smoke detectors are so equipped.

Kambouris, et al., U.S. Pat. No. 5,489,889, disclosed a universal earthquake safety valve for shutting off utilities, such as gas and electricity, automatically, in the case of an emergency, such as an earthquake, fire or the presence of hazardous fumes.

An electrical signal was provided by a smoke detector or a hazardous fumes detector to trigger a relay, which relay provided signal to an electrical power breaker to interrupt the power whenever smoke or hazardous fumes were detected. This device also was limited to use with smoke detectors equipped with an electric signal output terminal.

Maumen, U.S. Pat. No. 54,508,568, disclosed a receptacle safety de-energizer. The disclosed device plugged into a standard wall receptacle, and in turn accepted the plug of an appliance cord. The device provided a control circuit responsive to an audible alarm from a smoke detector; when the alarm sounded, the control circuit activated an automatic switch that disconnected power to the appliance. In an alternative embodiment, the device was hard wired into the building wiring system. An advantage of Maumen's device was that it was not limited to use with smoke detectors equipped with an electric signal output terminal. Morris U.S. Pat. No. 5,587,705 disclosed a multiple smoke detector system for transmitting signals and activating multiple smoke detectors, But, no disruption of a power source to an appliance or utility.

As a potential matter, a significant proportion of all fires start well after the presence of smoke or fumes, due to the inadvertent or improper usage of electrical appliances occur in kitchens and residents garages and or clothes dryer. It is desirable to provide a means to protect such areas by shutting off and interrupt electrical power to an electrical circuit whenever a smoke detector detects smoke or fumes in the effected area. Moreover, it is desirable to provide a means to stop a fire hazard before it's beginning and while there is only smoke being produced, further it is more desirable to provide a portable system that can be easy to install with out hiring an electrician and used with portable smoke detectors regardless of whether they incorporate an electrical signal output terminal and of which need not be electrically hard wired and connected to the smoke detector such as Maumen's.

### SUMMARY OF INVENTION

According to the present invention there is provided a combination smoke detector with a R.F transmitter, using a D.C powered circuit breaker tripping component of the invention's module's for interrupting A.C. power to an electric circuit when smoke is detected. The combination includes a smoke detector of conventional construction that generates a first electric signal in response to the presence of smoke and fumes. The smoke detector may be mounted on a ceiling wall, or other suitable location in the vicinity of one or more electric appliances that present a potential fire hazard. A radiant energy generating means is incorporated with the smoke detector and emits radiant energy in response to the first electric signal when activated by smoke or fumes by a detector. In a first embodiment of the invention, the radiant energy generating means is a radio frequency beam sender tuned to a selected frequency. The combination further includes a modified 110-volt powered lamp and appliance remote control switch made by Radio Shack. The electrical socket for plugging an A.C. lamp or appliance is replaced with an electric timer for the time delay in the system's operation, which automatically energizing a circuit breaker tripping system of the present invention operation, by activating a slightly modified General Motors trunk latch release device. The D.C.powerd, Motor driven worm gear retraction device, retracts a steel wire attached to a circuit breaker toggle, to an OFF position. Further it is desirable to have a portable, and an automatic remote controlled power interruption system activated, by an R.F.signal generated from a smoke detector or device in a new portable and useful invention to save lives and property by tripping a circuit breaker off before a fire starts. In the first embodiment, the incident radiant energy sensing means includes an incident radio frequency beam detector tuned to a selected frequency, and the means responsive to the incident radio frequency beam detector is a portable system, and not hard wired to the A.C. wiring system like the previous sighted patents disclosures.

In a second embodiment, the radiant energy generating means include an infrared beam sender and the incident radiant energy sensing means includes an incident infrared beam detector.

In a third embodiment, the radiant energy generating means includes a sonic energy beam generator such as an electric buzzer or horn, and the incident radiant energy sensing means includes sonic energy beam detector. Important objectives of the present invention therefore include the following; it is an objective of the invention to provide a device for interrupting electrical power in an electrical circuit when ever there is smoke or fumes in the vicinity of a detection device.

It is a further objective of the invention to provide such a device, where in the device includes a smoke or carbon monoxide detector that generates a first electric signal when smoke or fumes is present, a radiant energy generating means responsive to the first electrical signal, an incident radiant energy sensing means, and means responsive to the radiant energy sensing means for tripping a circuit breaker. A further object of the invention is to provide such a device, where in the radiant energy means include the radio frequency beam sender, and the incident radiant energy sensing means include an incident radio frequency beam detector. Another object of the invention is to provide such a device, where in the radiant energy generating means includes the sonic energy beam generator and the incident radiant energy sensing means include an incident sonic energy beam detector. A further object is to provide such a device and components with a transmitter and radio frequency receiver of which is powered by direct current and portable.

### DESCRIPTION OF THE DRAWINGS

FIG. 1 is a perspective view of a kitchen showing the main component of the inventions operation. Consisting a smoke detector incorporating a radiant energy generating means for emitting a radio signal in response to ambient smoke, toward a wireless remote switch incorporating a timer and lever switch, and having a jumper cable attached from lever switch, to the retractors worm drive motor.

FIG. 1 Is a perspective view of the AUS of a kitchen showing the main components of the invention in operation that is, a smoke detector equipped with a radiant energy generating means emitting a signal in response to ambient smoke toward a modified wireless remote switch and components for a emergency shut of appliances and utilities.

FIG. 2 Is a block diagram of the AUS.

FIG. 3 Is a diagram of the components of the AUS.

### LIST OF REFERENCE NUMERALS

10 Smoke detector

11 RF Transmitter

11(A) RF signal

12 RF receiver decoder

13 Remote power switch

14 Time delay timer

15 Lever switch

16 DC battery pact.

17 DC motor driven worm gear drive retractor

18 Steel trip wire

19 AC or DC Load Center

20 Circuit Breakers

21(A) Ground Jumper Cable

21(B) Ground Jumper Cable

22 Component Box

22(A) Test switch energize retractor device

23 Stove top

24 Smoke

25 Kitchen view of the operation of AUS

26 Smoke detector test button

31 Pot

### DETAILED DESCRIPTION OF THE PREFERRED EMBODIMENT

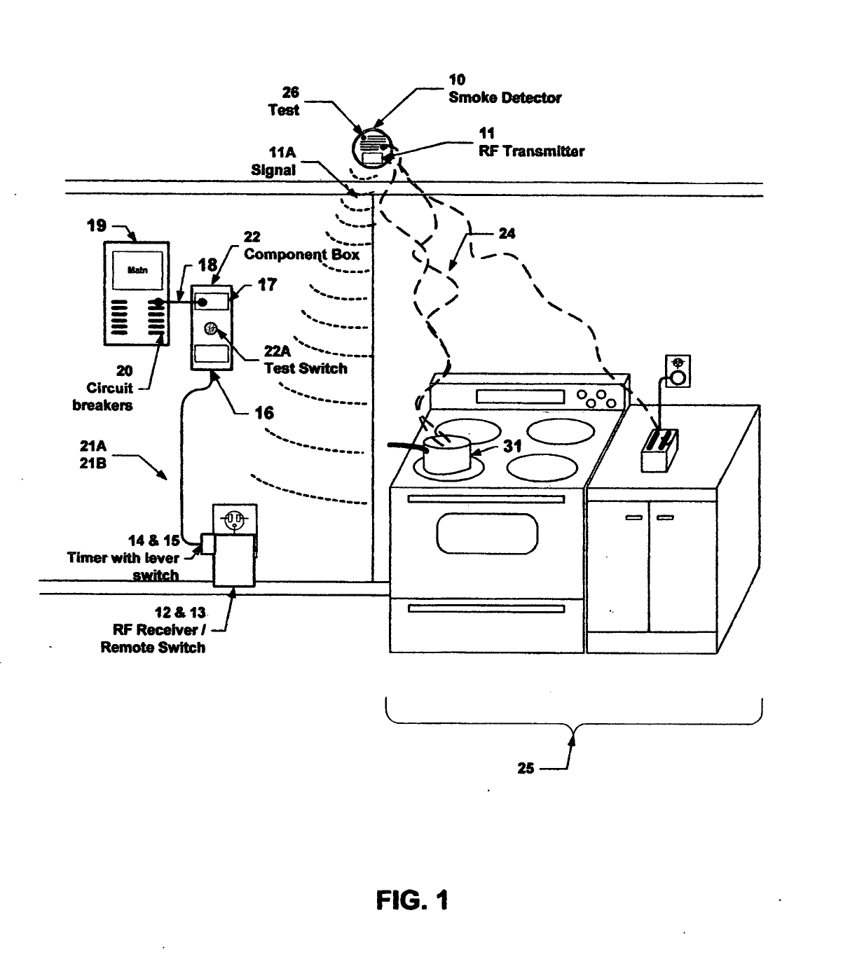

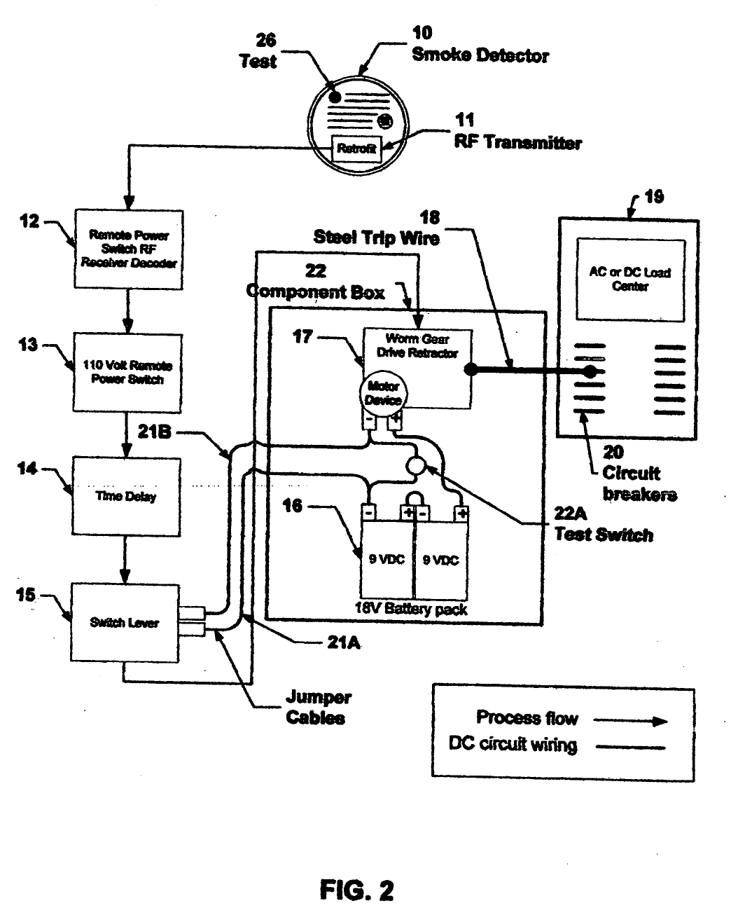

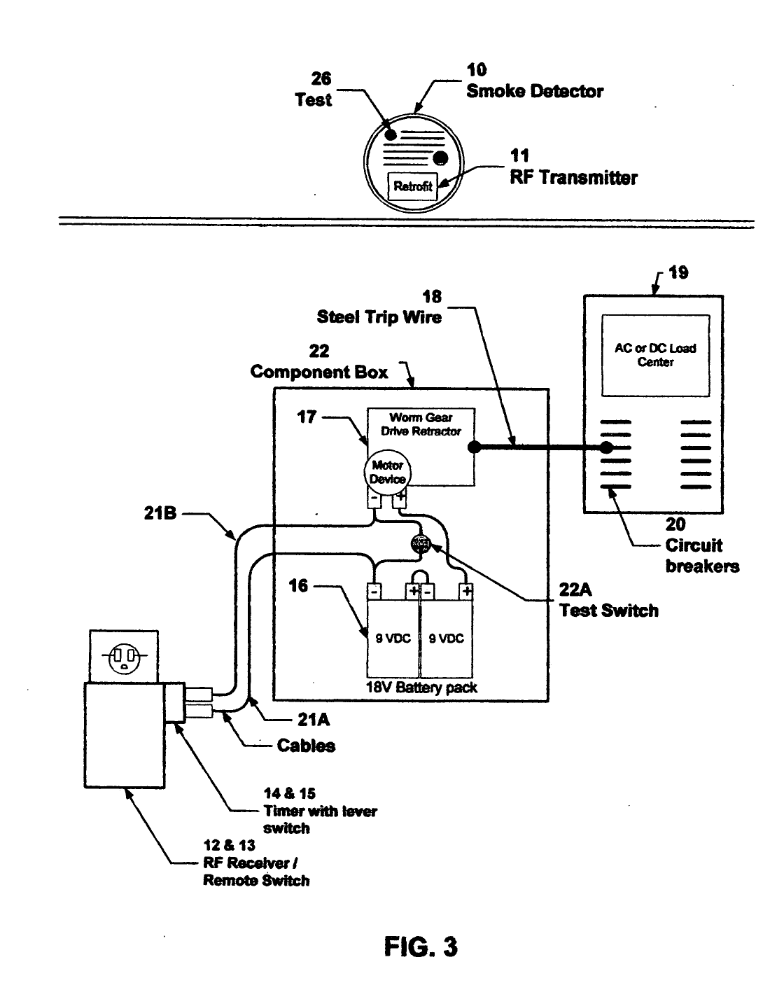

Referring now to FIG. 1 A typical embodiment of the the present invention is strated in FIG. 1 A modified smoke detector 10 is shown mounted to the ceiling of kitchen. The smoke detector 10 is of conventional design, such as model SA150LTD of first alert, Aurora, Ill. See, for example, U.S. Pat. No. 4,827,244 to Bellavia et al., which by this record is incorporated here in for reference purposes. Although a 9-volt battery powers the reference smoke detector model, while an A.C. current powered smoke detector may be used instead. There is an R.F.transmitter, 11 incorporated with in the smoke detector 10 and wired parallel to the alarm buzzer not shown. The radio frequency beam 11(a) toward the RF receiver decoder 12. In FIG. 1 over heated food in pot 31 on the electric range 23 is emitting smoke 24 smoke detector Sensing the presence of smoke 24, the smoke detector 10 is in alarm condition and, by generating a first electric signal is emitting a sound warning by means of an electric buzzer or other electrically-powered sound alarm (not shown). In addition the radio frequency beam transmitter 11 which is wired and parallel with the electric buzzer or alarm has likewise been energized by the first electric signal and is emitting a radio frequency beam 11(a) at some desired radio frequency, to a portable R.F receiver decoder 12 and the portable wireless remote switch 13. FIG. 2 is a block diagram of the inventions components.

The combination further includes a modified lamp and appliance remote control device made by Radio Shack Corp.

Along with a modified electric timer is installed in place of the electric plug socket. The timer is slightly modified with the hour gears removed, and the minute gear spine for turning an hour gear is ground to form a cam (not shown). The high side of cam, engages the lever of the lever switch 15 (not shown) and closes contact point (not shown). The lever switch 15 is used to energize the worm gear drive motor assembly 17. Further In the (alternative) a solid-state timer could be used to replace a gear type timer, and installed in the smoke or fume detector. A time delay is needed for minor smoke problems, giving time for smoke detector to clear and not transmit a R.F signal to the RF receiver decoder in the remote switch 13. The portable remote switch module 13 is plugged into an AC receptacle close to a building AC load center 19 illustrated in FIG. 1 of which holds load center circuit breakers 20 for the electric circuits of a house or building. A portable component box 22 is secured to wall by screws, against the AC load center 19. The component box 22, which incorporates components of inventions circuit breaker tripping system, for remotely tripping a circuit breaker toggle off to disrupt electric current to an appliance or utility. The components in box 22 contains a battery pact 16 and a manual test switch 26(a) to energize worm drive motor and to test the retraction of wire 18 which is attached to circuit breaker toggles to be retracted and tripped off. In the event of extreme smoke, the smoke detector 10 activates the RF transmitter 11, thereby sending a signal to RF receiver decoder 12 of the invention, which activates the remote switch 13, and they're by energizing the delay timer 14. After a minute the timer 14 (not shown) minute gear with cam engages the lever of the lever switch 15 and closes a DC circuit of the worm drive motor, further one of two cables 21(a) of which one is attached to negative side of the eighteen volt battery pact 16, and attached to one of two terminals on the lever switch (not shown), The positive cable (not shown) of the battery pact is connected to the worm drive motor circuit of the retractor device 17, the second cable 21(b) is attached to the second terminal of the lever switch 15, this cable, returns to worm drive motor power supply and for grounding system and activating the worm drive retractors motor 17, thus turning the worm screw (not shown) and causing a nut to rotate down screw pulling a steel wire 18 of which one end is attached to the nut there by retracting the steel wire 18 of which the opposite end is attached to the toggle of the desired circuit breaker 20 to be tripped off. The operation of a DCmotor driven retraction device and a solenoid are well known in the art and need not be elaborated on. The steel wire 18 of the invention's components is a steel fishing leader with original hooking clips on each end for attaching to the worm drive retraction nut, which rotates down worm screw when motor is activated. The opposite clip of wire is attached to the circuit breakers toggle 20 to be tripped to an off position and thus shutting off an AC or DC circuit to an appliance, or a solenoid, for a gas appliance, or clothes dryer. There is further provided a test switch 22(a) for manually checking the retraction system. In addition all smoked detectors have a standard test button 26. This test button is used to activate the whole system of my claimed invention. The reset of a tripped circuit breaker is done by pushing the tripped off circuit breaker back to an on position, which pulls the tripping wire along with the worm drive nut back to a tripping mode. There is also provided with the wirless remote switch transmitter 11 a second button which when pushed, turns off the remote switch by sending a second signal for turning off the remote switch, before the system compleats a tripping mode. FIG. 1 kitchen, illustrates system procedure from stove top 23 and counter top appliance circuit, pot 31 has smoke emitting from an over heated pot 31 or counter top device's making smoke 24 is received by smoke detector 10 is activated by the smoke or fume hazzard, energizes the RF transmitter 11, which transmitts an RF signal 11(a) to the receiver decoder 12 which in turn activates the portable remote switch 13, which in turn energizes and starts the time delay timer 14, and closing the lever switch contact points (not shown)15, intern connects wiring circuit of 21(a) and 21(b), which in turn grounds and energizes the motor driven worm drive 17, which in turn retracts worm drive nut along with steel cable 18 which is attached to the desired circuit breaker to be tripped off, by retracting a toggle button of a circuit breaker 20 to an off position. There by eliminating the AC or DC power to an appliances or utility and stopping any over heating and eliminating a fire hazard before a fire can start. My system for a new invention of an APPLIANCE AND UTILITY SENTRY (ASU) for the protection of life and property.

In a second, alternative embodiment, instead of a radio frequency beam generator, the radiant energy generating means includes a sonic energy beam generator, such as an electric buzzer as is commonly included in smoke detectors. In that event, the incident radiant energy sensing means is an incident sonic energy beam detector, which generates a second electric signal when an incident sonic beam is detected. A suitable incident sonic energy detector has been described in U.S. Pat. No. 5,508,568 to Madmen. Infrared bean senders are well known, being commonly used in remote control devices for television sets, Likewise, the incident radiant energy sensing means includes an incident infrared beam detector to generate a second electric signal when an incident infrared beam is detected, such detectors also being well known in the prior ART, and typically include an infrared-sensitive photo-transistor. See, for example, U.S. Pat. No. 4,827,244 to Bella via et al., at col. 6. It will be appreciated that various modifications can be made to the exact form of the present invention without departing from the scope thereof. The range of applications of the invention is not limited just to electric appliances. For instance, the invention can also be used to shut off the flow of gas to a kitchen gas range equipped with an electric solenoid gas flow control. It is accordingly intended that the disclosure be taken as illustrative only and not limiting in scope, and that the scope of the invention be defined by the following claims.

I claim:

1. A portable Appliance and Utility Sentry (AUS) that is a portable circuit breaker interrupting system. The AUS automatically interrupts a power source to an appliance or utility if a noxious gas or smoke detector device is activated. This system is comprised of:
1.1. A noxious gas or smoke detector with a RF transmitter for sensing the presence of a hazardous fume and then sending a RF single to actuate the circuit breaker retraction system of the AUS.
1.2. The AUS components comprising means for receiving the RF single from an activated detector, switching and driving a direct current (DC) motor that turns a worm drive gear to create a pulling force on a tethered cable to a circuit breaker switch, which physically trip the circuit breaker there by stopping current flow.

2. The combination of claim 1, wherein the radiant energy generating means includes a radio frequency beam sender and the incident radiant energy sensing means includes an incident radio frequency beam detector.

3. The device of claim 2, wherein the remote switch uses a 110 Volt power source incorporating a clock timer and a lever switch incorporated with timer for a time delay and a lever switch for closing a circuit for the activation of the worm drive motor retraction device of the invention components.

4. The combination of claim 2, wherein the lever switch has contact points when closed, grounds a d.c.motor of the retractor device, thus turning the worm shaft and causing worm nut to retract a steel cable attached to nut and a circuit breaker toggle.

5. The combination of claim 1, wherein the radiant energy generating means includes a sonic energy beam generator and the incident radiant energy sensing means includes an incident sonic energy detector.
I claim a modified RF remote control switch, having a time delay timer, activating a relay and using a DC power source
